(19) United States
(12) Patent Application Publication
(10) Pub. No.: US 2018/0259023 A1
(43) Pub. Date: Sep. 13, 2018

(54) A Spring for an Electromagnetic Actuator

(71) Applicant: ThermoLift, Inc., Stony Brook, NY (US)

(72) Inventors: Peter Hofbauer, West Bloomfield, MI (US); James F. Smith, Smithtown, NY (US); Seann Convey, Roslyn, NY (US); David Yates, Ann Arbor, MI (US)

(73) Assignee: ThermoLift, Inc., Stony Brook, NY (US)

(21) Appl. No.: 15/760,303

(22) PCT Filed: Sep. 15, 2016
(86) PCT No.: PCT/US16/51821

§ 371 Date: Mar. 15, 2018

Related U.S. Application Data
(60) Provisional application No. 62/218,597, filed on Sep. 15, 2015.

(51) Int. Cl. F16F 1/02; F16F 1/06; F16F 3/04; F01L 9/04; F01L 1/46; F02G 1/053

(52) U.S. Cl. CPC F16F 1/028; F16F 1/06; F16F 3/04; F01L 9/04; F01L 1/462; H01F 7/1638; F16F 2226/04; F16F 2232/08; F16F 2234/02; F01L 2009/0434; F02G 1/053

(57) ABSTRACT

Reciprocating apparatuses such as a displacer in a Stirling engine or Vuilleumier (thermally-driven) heat pump and such as a poppet valve in an internal combustion engine have been known to be built with a mechatronic actuator. The reciprocating element has two springs in compression biased against each other. It has been found that conventional springs in compression introduce losses. A spring is disclosed in which a portion of the coil is wound in a clockwise direction and a portion is wound in a clockwise direction. Also, in reciprocation, the spring is in compression at one end of travel and in tension at the other end of travel.

### FIELD OF INVENTION

The present disclosure relates generally to actuation systems with springs.

### BACKGROUND

It is known in the prior art to use mechanical actuation to open and close intake and exhaust valves in internal combustion engines. An illustration of the mechanism is shown in FIG. 1. A camshaft 12 rotates at half engine crankshaft speed in a typical four-stroke engine. A lobe 14 on camshaft 12, when pointing downward, pushes on a finger 16, which pushes on valve 18 to cause valve 18 to lift off of a valve seat 20. Stiff coil springs 22 keep valve 18 pushed up against valve seat 20 whenever the base circle of camshaft 12 is riding on finger 16. When valve 18 is allowed to lift off of valve seat 20 (pushed downward in the orientation in FIG. 1), if valve 18 is an intake valve, air flow from an intake port 26 in cylinder head 24, is allowed to enter the combustion chamber (which is generally below the head of valve 18; however, insufficient detail is shown to delimit the combustion chamber). If valve 18 is an exhaust valve, when valve 18 is open, exhaust gases escape from the combustion chamber into exhaust port 26.

One problem with a conventional mechanical apparatus is that the timing of opening of valve 18 by lobe 14 is synchronized with engine speed. However, it is preferable for the valve timing to be different for a low torque operating condition than for a high torque operating condition. There are also desired accommodations for engine speed. However, in a system with fixed valve timing, the timing is known to be a compromise that gives acceptable idle and high performance. It is well known that better idle quality, fuel economy, and top end performance is available with variable valve timing. Hydraulic systems that provide a modicum of control over valve timing are well known and in production in many vehicles presently in use.

Because such variable valve timing mechanisms have a limited range of authority and change the timing of the valve event, typically not the duration, they are unable to fully exploit the advantages available by greater control over the valve event. There has been significant development in the field of camless engines or electromechanical valve actuation in which the valve timing is controlled independently of the engine's crankshaft position thereby allowing control over both the timing and duration of the valve event. Such a system is illustrated in FIG. 2 which shows a cross-section illustrating a valve actuator assembly for an intake or exhaust valve of an internal combustion engine. Valve actuator assembly 210 includes an upper electromagnet 212 and a lower electromagnet 214. As used throughout the description of FIG. 2, the terms “upper” and “lower” refer to positions relative to the combustion chamber or cylinder with “lower” designating components closer to the cylinder and “upper” referring to components axially farther from the corresponding cylinder. An armature 216 is fixed to, and extends outward from, an armature shaft 218, which extends axially through a bore in upper electromagnet 212 and lower electromagnet 214, guided by one or more bushings, represented generally by bushing 220. Armature shaft 218 is operatively associated with an engine valve 230 that includes a valve head 232 and valve stem 234. Armature shaft (armature stem) 218 is located in stem hole 219. Depending upon the particular application and implementation, armature shaft 218 and valve stem 234 may be integrally formed such that armature 216 is fixed to valve stem 234. However, in the embodiment illustrated, shaft 218 and valve stem 234 are discrete, separately moveable components. This provides a small gap between shaft 218 and valve stem 234 when armature 216 is touching upper core 252. Various other connecting or coupling arrangements may be-used to translate axial motion of armature 216 between upper and lower electromagnets 212, 214 to valve 230 to open and close valve 230 to selectively couple intake/exhaust passage 236 within an engine cylinder head 238 to a corresponding combustion chamber or cylinder (not shown).

Actuator assembly 210 also includes an upper spring 240 operatively associated with armature shaft 218 for biasing armature 216 toward a neutral position away from upper electromagnet 212, and a lower spring 242 operatively associated with valve stem 234 for biasing armature 216 toward a neutral position away from lower electromagnet 214.

In U.S. application Ser. No. 14/391,787, which is commonly assigned, a thermally-driven (sometimes referred to as Vuilleumier) heat pump is disclosed in which hot and cold displacers are actuated via electromagnetic actuators.

Referring now to FIG. 3, a heat pump 50 has a housing 52 and a cylinder 54 into which hot displacer 62 and cold displacer 66 are disposed. Displacers 62 and 66 reciprocate within cylinder liner 54 moving along central axis 53. An actuator for hot displacer 62 includes: ferromagnetic elements 102 and 112, electromagnet 92, springs 142 and 144, and a support structure 143. Support structure 143, as shown in FIG. 3 is attached to the electromagnet 92, which is coupled to a central post 88 that is coupled to a cold end 86 of housing 52. Post 88, electromagnet 92, and support structure 143 are stationary. When hot displacer 62 reciprocates upward from the position shown in FIG. 3, spring 142 is compressed to a greater degree than its equilibrium preload and 144 is under a lower compression. Electromagnet 92 is energized to pull ferromagnetic elements 102 or 112 toward it, against the spring forces of springs 142 and 144. Analogously, cold displacer 66 has a cold actuator that includes: an electromagnet 96 coupled to post 88, a support structure 147 coupled to electromagnet 96, and springs 146 and 148. Spring 146 is coupled between support structure 147 and a first cap 126 of cold displacer 66. Spring 148 is coupled between support structure 147 and a second cap 136 of cold displacer 66. Electromagnet 92 and 96 are controlled via an electronic control unit (ECU) 100.

Ferromagnetic blocks 102, 112, 106, and 116 are coupled to: a standoff associated with a first cap 122 of hot displacer 62, a second cap 132 of hot displacer 62, a standoff associated with first cap 126 of cold displacer 66, and second cap 136 of cold displacer 66, respectively. Openings are provided in second cap 132 of hot displacer 62, and first and second caps 126 and 136 of cold displacer 66 to accommodate post 88 extending upwardly through cold displacer 66 and into hot displacer 62.

An annular chamber is formed between a portion of the inner surface of housing 52 and the outer surface of cylinder 54. A hot regenerator 152, a warm heat exchanger 154, a cold regenerator 156, and a cold heat exchanger 158 are disposed within the annular chamber. Openings through cylinder 54 allow fluid to pass between the interior of cylinder 54 to the annular chamber. Openings 166 allow for flow between a cold chamber 76 and cold heat exchanger 158 in the annular chamber. Openings 164 allow flow between a warm chamber (which has substantially no volume when the displacers are in the position shown in FIG. 3) and the annular chamber. Heat pump 50 also has a hot heat exchanger 165 that is provided near a hot end 82 of housing 52. Openings 162 through cap 82 lead to heat exchanger 165 which has passages 163 that lead to the annular chamber. Hot heat exchanger 165 may be associated with a burner arrangement or other energy source.

Continuing to refer to FIG. 3, a fluid that is to be heated flows to warm heat exchanger 154 into opening 174 and out opening 172, cross flow. Fluid that is to be cooled flows to cold heat exchanger 158 in at opening 176 and exits at opening 178. The flow through the heat exchangers may be reversed, parallel flow.

Stirling engines have a single displacer that can be driven similar to either of the displacers in the thermally-driven heat pump.

In Stirling engine, thermally-driven heat pump, and internal combustion engine applications, there are two springs that are in compression acting in opposite directions with a preload. When the reciprocating element, i.e., the displacer or the valve, is in one of its extreme positions, there is an unbalanced spring force, but the reciprocating element is caught by the electromagnet. When it is desired for the valve or displacer to shuttle to the other end of travel, the electromagnet is de-energized and via the imbalance in the spring forces, the displacer or valve is forced to the other end.

In the internal-combustion engine application of FIG. 2, the valve lifts off the valve seat typically a little less than 8 mm. In the heat pump sized for domestic use, the displacers move about 50 mm. Thus, the spring compresses a greater distance. A conventional coil spring unwinds when compressed and winds when allowed to decompress (or is put in tension). The outer diameter of the coil spring increases when compressed and the decreases when pulled in tension (or allowed to decompress). The spring is free to rotate on each end to allow the winding and unwinding. The friction due to winding of the spring end against the housing, the changed in diameter of the spring, bending of the spring from its vertical position, and internal stresses lead to significant irreversible energy losses. Such losses are high enough in the heat pump application that the displacer, when perturbed from its neutral state, fails to oscillate sufficiently, but instead completely damps within 2-3 cycles, as shown in FIG. 4. The shortfall in the force of the spring to cause the displacer to nearly reach the other end of travel is made up by a much greater electrical input to the coils than is acceptable for good efficiency of the system. It is suspected that similar inefficiencies in the valvetrain system also exist, but are less evident due to the lesser travel distance of the engine valve compared to the displacers in the heat pump system. The damping in FIG. 4 is due to damping in the spring as well as flow losses in the thermally-driven heat pump regenerators and heat exchangers.

A spring system that provides greater efficiency is desired.

### SUMMARY

A reciprocating apparatus having a stationary housing, a reciprocating element adapted to travel between a first position and a second position, a spring having a first end affixed to the housing and a second end affixed to the reciprocating element, a first ferromagnetic block coupled to the reciprocating element at a first location, a second ferromagnetic block coupled to the reciprocating element at a second location, and an electromagnet coupled to the stationary housing. The spring is in tension and the first ferromagnetic block is proximate the electromagnet when the reciprocating element is in the first position. The spring is in compression and the second ferromagnetic block is proximate the electromagnet when the reciprocating element is in the second position.

The apparatus also includes an electronic control unit (ECU) coupled to the electromagnet wherein the ECU commands the electromagnet to attract the first ferromagnetic block.

The spring is a coil spring comprised of a counterclockwise wound portion and a clockwise wound portion.

The spring is machined from a tube or a billet and the spring has clockwise helical openings over a first portion of the length of the tube and has counterclockwise helical openings over a second portion of the length of the tube.

The reciprocating element is a poppet valve and the housing is a cylinder head of an internal combustion engine in some embodiments. In other embodiments, the reciprocating element is a displacer. The housing has a cylinder in which the displacer is adapted to reciprocate, a first end cap coupled to a first end of the cylinder and a second end cap coupled to a second end of the cylinder.

In some embodiments, the apparatus has first and second springs coupled between the reciprocating element and the housing. The second spring has a smaller diameter than the first spring. The second spring is disposed within the first spring. A start of the first spring and a start of the second spring are located in the same plane and evenly displaced circumferentially. In another alternative, the first and second springs have the same diameter and coils of the first spring interleave with coils of the second spring. A start of the first spring and a start of the second spring are located in the same plane and evenly displaced circumferentially.

In some embodiments, the sense of the first spring is opposite the sense of the second spring.

Also disclosed is an apparatus that has a stationary housing, a reciprocating element adapted to travel between a first position and a second position, and a spring affixed to the housing and to the reciprocating element. The spring has a clockwise portion having at least two starts and a counterclockwise portion having at least two starts. The spring is in tension when the reciprocating element is in the first position and the spring is in compression when the reciprocating element is in the second position.

In some applications, the apparatus also has a first ferromagnetic block coupled to the reciprocating element at a first location, and a second ferromagnetic block coupled to the reciprocating element at a second location. The first location is displaced from the second location along the direction of reciprocation of the reciprocating element. The spring is in tension and the first ferromagnetic block is proximate the electromagnet when the reciprocating element is in the first position; and the spring is in compression and the second ferromagnetic block is proximate the electromagnet when the reciprocating element is in the second position.

The apparatus may optionally include an electronic control unit (ECU) electronically coupled to the first and second electromagnets wherein the ECU commands the first electromagnet to attract the ferromagnetic block at some periods and commands the second electromagnet to attract the ferromagnetic block at other periods.

The spring may be machined from a tube. The spring has clockwise helical openings over a first portion of the length of the tube and counterclockwise helical openings over a second portion of the length of the tube.

A reciprocating apparatus has a stationary housing, a reciprocating element adapted to travel between a first position and a second position in a direction of reciprocation, and a spring, with a first end of the spring affixed to the housing and a second end of the spring affixed to the reciprocating element. A majority of a length of the spring is substantially symmetric about a plane bisecting the spring with the plane perpendicular to a central axis of the spring.

The apparatus may also include a ferromagnetic block coupled to the reciprocating element and an electromagnet coupled to the stationary housing. The electromagnet is substantially in contact with the ferromagnetic block whenever the reciprocating element is in the first position.

Proximate the first end is a first helical section, the first helical section has at least two helical grooves defined therein. Proximate the second end is a second helical section; the second helical section has at least two helical grooves defined therein. A groove-less central section is located between the first and second helical sections.

The apparatus has first and second ferromagnetic blocks coupled to the reciprocating element and first and second electromagnets coupled to the stationary housing. The second electromagnet is substantially in contact with the second ferromagnetic block when the reciprocating element is in the second position. Also disclosed is reciprocating apparatus having: a stationary housing, a reciprocating element adapted to travel between a first position and a second position with respect to the housing, and a spring system comprising at least one spring with a first end of the spring system coupled to the housing and a second end of the spring system coupled to the reciprocating element. The spring system has a clockwise portion and a counterclockwise portion. The spring is in tension when the reciprocating element is in the first position and the spring is in compression when the reciprocating element is in the second position.

According to an embodiment of the disclosure, friction in the reciprocating apparatus is reduced thereby improving system efficiency. Furthermore, as a coil grabs the reciprocating element near one of its ends of travel to bring the reciprocating element to its end of travel, the closer that the reciprocating element gets to the end of travel under the forces provided by the spring, the lower the current required in the coil.

### BRIEF DESCRIPTION OF THE DRAWINGS

FIG. 1 is an illustration of a prior art poppet valve with a camshaft actuation for a conventional internal combustion engine;

FIG. 2 is an illustration of a prior art camless valve actuation mechanism for an internal combustion engine;

FIG. 3 is an illustration of a thermally-driven heat pump having electromagnetic actuators on the hot and cold displacers;

FIG. 4 is an illustration of the damping of a displacer in a thermally-driven heat pump application using a prior art spring;

FIG. 5 shows a machined spring in an isometric view;

FIG. 6 shows the machined spring of FIG. 5 in a cross-sectional view;

FIG. 7 shows a spring having clockwise and counter clockwise portions;

FIG. 8 is an illustration of the damping of a displacer in a thermally-driven heat pump application using a spring according to an embodiment of the present disclosure;

FIG. 9 shows another alternative for an electromagnetic actuator arrangement;

FIG. 10 is an illustration of two conventional coil springs interleaved;

FIG. 11 is an illustration of a heat engine with coils acting upon a ferromagnetic block to actuate a displacer within the heat engine;

FIG. 12 is an illustration of a spring of one sense that can be inserted into a spring of the opposite sense; and

FIG. 13 is a top view of the springs in FIG. 12 showing the starts.

### DETAILED DESCRIPTION

100441 As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

One alternative to a conventional coil spring is a machined spring 300, one embodiment of such a spring shown in FIG. 5. Spring 300 may be formed from a billet or a cylinder. The embodiment in FIG. 5 has two helixes in the upper half and two helixes in the lower half defined therein. A first helix 302 has a start 304 and continues downward along the spring with the ending not visible in the view in FIG. 5. A second helix 303 has a start that is 90 degrees displaced from start 304 and has an end 306. The rotation is clockwise as taken looking from end 316 going from start 304. Away from end 316, a third helix 309 has a start that is not visible in FIG. 5 and an end 314. Nested in helix 309, is a fourth helix 308 that has a start 310 and an end (not visible). Starts of helixes 302 and 303 are rotated about 180 degrees with respect to each other as are the ends of helixes 302 and 303 having the same 180-degree displacement. Helixes 308 and 309 have similarly displaced starts and ends. Top 316 of spring 300 has eight threaded holes for affixing the spring to a housing (not shown). A cross-sectional view of spring 300 is shown in FIG. 6.

Spring 300 is one example of such a machined spring having two helixes in each of the upper and lower portions and where the starts and stops of the helixes are aligned in one of two circumferential positions 180 degrees apart. The number of helixes in the upper portion of the spring may alternatively be one or more than two. The starts and ends of the helixes in the upper half might be offset from those in the bottom half. For example, with two helixes in the upper half, they may start 180 degrees displaced from each other, but then two helixes in the lower half start 90 degrees displaced from the helixes in the upper half in one embodiment. Spring 300 could alternatively be formed by any suitable process, including, but limited to casting and forging.

An illustration of a spring system in which a first coiled spring portion 340 wound in a counterclockwise wind, when looking from the top end and going from the top to the bottom and a second coiled spring portion 342 wound in a clockwise wind is shown in FIG. 7. Spring portion 342 could alternatively be switched with spring portion 340. (The convention by which clockwise and counterclockwise are defined is defined herein. Regardless of the convention applied, the important matter is that spring portion 340 has an opposite sense with respect to spring portion 342.)

In the arrangement in FIG. 7, the two spring portions 340 and 342 are affixed to a common-central plate 348. In other embodiments, spring portions 340 and 342 are directly affixed to each other without plate 348. Spring 340 is affixed to an element 344 that is allowed to move, but not to rotate. The lower end of spring 342 is affixed to a completely fixed element 346 (e.g., a housing) that prevents displacement, rotation, bending, etc. Unlike elements 344 and 346, plate 348 is free to rotate. By allowing plate 348 to rotate freely, the friction of the spring end, or in this case ends, due to winding and unwinding is mitigated. Referring back to FIG. 5, a central portion 318 of machined spring 300 shuttles back and forth circumferentially when spring 300 compressed, uncompressed and/or pulled in tension in a periodic fashion. If the machined spring had grooves machined therein in a single sense, at least one end of the spring would rotate. This would disallow fixing the spring on both ends and it would cause friction between the end of the spring and whatever element against which it abuts. Machined spring 300 is symmetric about a plane 320 that bisects spring 300 with plane 320 perpendicular to a central axis 322 of spring 300. Because spring 300 is symmetric, an amount of rotation that an upper half of spring 300 undergoes when being deflected is the same as the amount of rotation that a lower half of spring 300 undergoes under the same deflection.

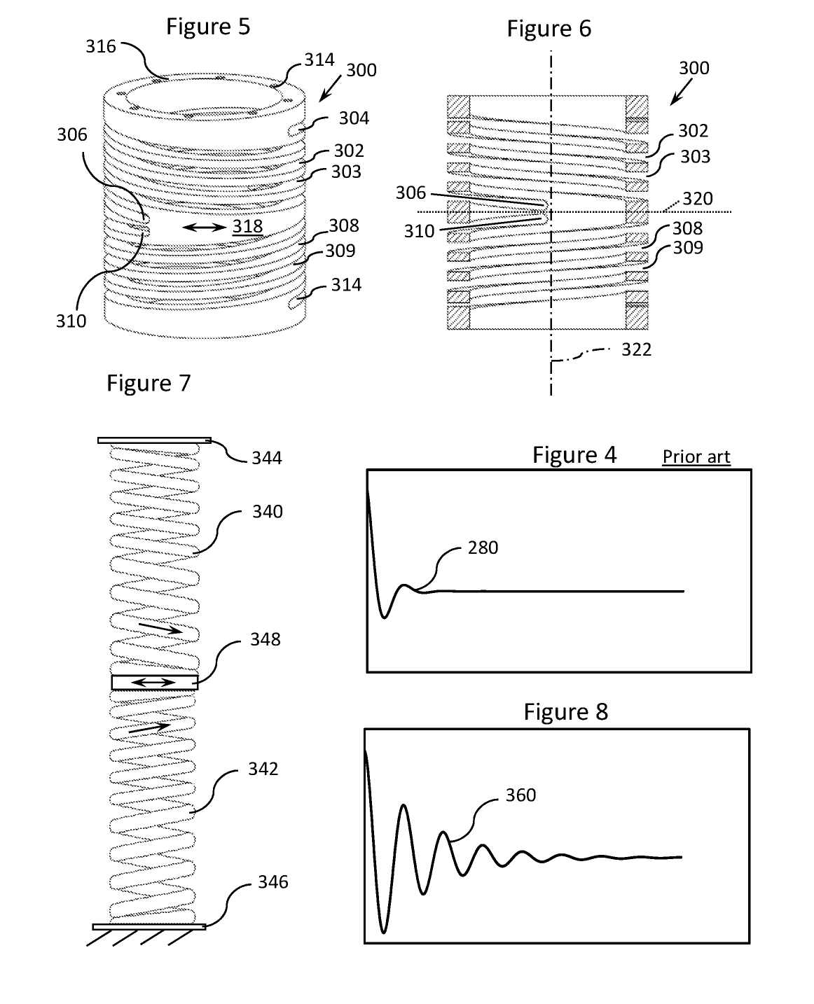

In FIG. 8, the displacer within the thermally-driven heat pump is shown to resonate through many cycles 360 before becoming completely damped. This is in contrast with FIG. 4 in which the displacer moves through about one cycle when completely damped. In both FIGS. 4 and 8, the damping is due to the spring as well as due to flow losses in the thermally-driven heat pump system. However, the many cycles of resonance with a spring that accesses both tension and compression, as in FIG. 8, is superior to the overdamped situation of two springs both in compression acting against each other as shown in FIG. 4.

In FIG. 2, an actuator arrangement is shown in which there is one ferromagnetic block 216 and two coils 250 and 260. In the heat pump illustrated in FIG. 3, the upper displacer has two ferromagnetic blocks 102 and 112 and one electromagnet 92. Another actuator 400 is shown in FIG. 9 (springs and housing not shown) that has a first ferromagnetic block 402 coupled to a second ferromagnetic block 404 via a connector 406. A first coil 408 acts upon ferromagnetic block 402 when energized to pull first ferromagnetic block 402 (and also connector 406 and second ferromagnetic block 404) to first coil 408. Energizing a second coil 410 acts on second ferromagnetic block 404 to pull second ferromagnetic block 404 to second coil 410.

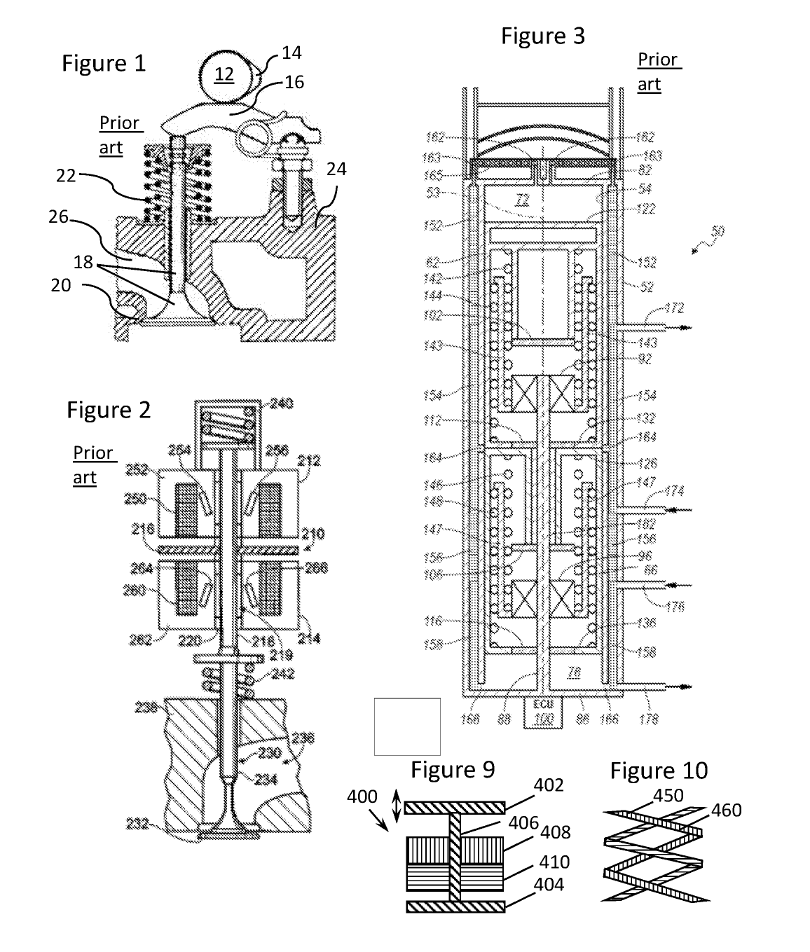

Spring 300 in FIG. 5 is a multi-start spring. A conventional coil spring can be multi-start as well. Referring to FIG. 1, coil springs 22 include an outer spring with a first diameter and an inner spring of a second diameter that is less than the first diameter. The first and second starts lie in the same plane. Now referring to FIG. 10, two coils 450 and 460 are interleaved. Coils 450 and 460 are of the same diameter with their individual coils interleaved. Start of coil 450 is arranged opposite a start of coil 460 in this embodiment with two coils interleaved. If embodiments in which more coils are interleaved, the starts are evenly arranged circumferentially. In the present disclosure in which the spring system has a portion that is coiled clockwise and a portion that is coiled counterclockwise, spring 22 of FIG. 1 and coils 450 and 460 of FIG. 10 represent only a portion of the total spring system. These representations are simplified to show just a portion of the spring to indicate the multiple coil springs.

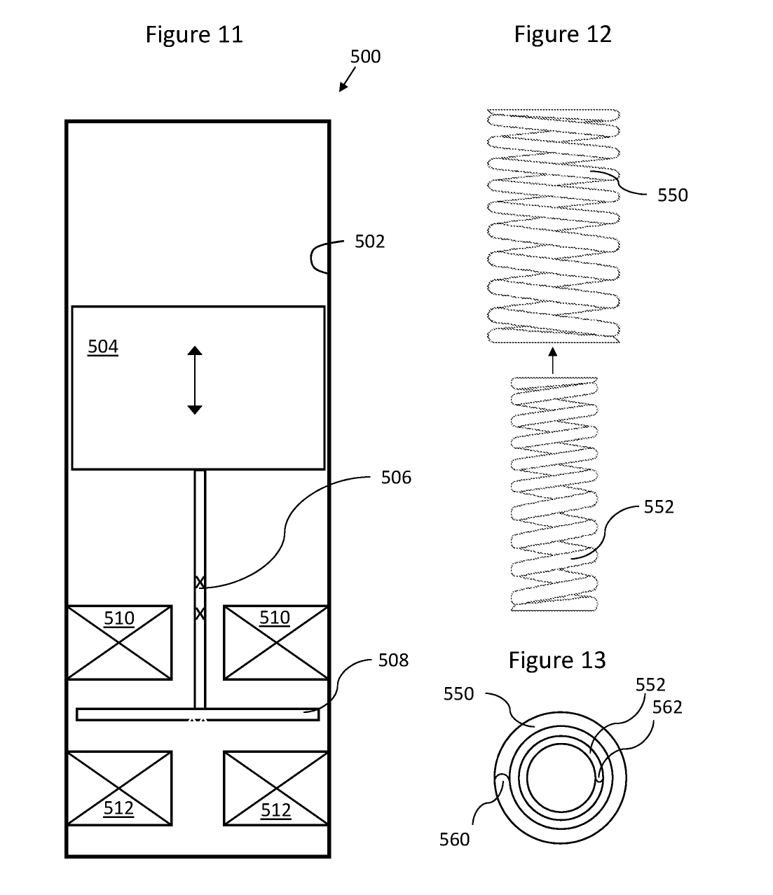

A simplified heat pump or heat engine 500 is shown in FIG. 11. Within cylindrical housing 502, a displacer 504 is caused to reciprocate, as indicated by the double ended arrow in 504. (A heat pump would have two displacers. For simplicity's sake only one displacer is shown in FIG. 10.) Displacer 504 is coupled to a ferromagnetic block 508 via a rod 506. An upper coil 510, shown in cross section, and a lower coil 512, also shown in cross section, can be commanded to act upon block 506. A spring (not shown in the interest of simplicity) is normally provided. In practice, a coil, say coil 510, is activated to cause block 506 to be attracted thereby raising displacer 504. The spring would be compressed and pushing downward on displacer 504 such that when coil 510 is deactivated displacer 504 moves downward. When coil 512 is activated, block 508 moves toward coil 512 pulling displacer 504 downward. The spring (not shown) would be in tension and wanting to pull displacer 504 upward.

Another spring alternative is shown in FIG. 12 with an outer spring 550 that is wound with a particular sense, counterclockwise if considered from top to bottom. A spring 552 with a smaller outside diameter has the opposite sense, clockwise, from top to bottom. Spring 552 can be placed within spring 550. The material and thickness of the wire to make the coil of spring 552 are chosen so that spring 552 has nearly the same spring constant as spring 550.

In FIG. 13, a top view of the nested springs shows a start 560 of spring 550 and a start 562 for spring 552. Because the springs are both in compression and tension, the ends of the springs, starts 560 and 562, are captured to allow tension to be developed in the springs.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art with respect to one or more characteristics are not outside the scope of the disclosure and may be desirable for particular applications.

We claim:

1. A reciprocating apparatus, comprising:
a stationary housing;
a reciprocating element adapted to travel between a first position and a second position with respect to the housing; and
a spring system comprising at least one spring with a first end of the spring system coupled to the housing and a second end of the spring system coupled to the reciprocating element wherein:
the spring system has a clockwise portion and a counterclockwise portion; and
the spring is in tension when the reciprocating element is in the first position and the spring is in compression when the reciprocating element is in the second position.

2. The apparatus of claim 1, further comprising:
a first electromagnet coupled to the housing at a first location;
a second electromagnet coupled to the housing at a second location;
a ferromagnetic block coupled to the reciprocating element with the ferromagnetic block arranged between the first and second electromagnets wherein:
the spring is in tension and the ferromagnetic block is proximate the first electromagnet when the reciprocating element is in the first position; and
the spring is in compression and the ferromagnetic block is proximate the second electromagnet when the reciprocating element is in the second position.

3. The apparatus of claim 2, further comprising: an electronic control unit (ECU) electronically coupled to the first and second electromagnets wherein the ECU commands the first electromagnet to attract the ferromagnetic block at some periods and commands the second electromagnet to attract the ferromagnetic block at other periods.

4. The apparatus of claim 1 wherein the reciprocating element is a poppet valve and the housing is a cylinder head of an internal combustion engine.

5. The apparatus of claim 1 wherein the reciprocating element is a displacer and the housing comprises a cylinder in which the displacer is adapted to reciprocate.

6. The apparatus of claim 1 wherein:
the spring is machined from a tube;
the spring has clockwise helical openings over a first portion of the length of the tube; and
the spring has counterclockwise helical openings over a second portion of the length of the tube.

7. The apparatus of claim 1 wherein:
the spring system comprises a first spring that is wound clockwise, the first spring having a first outer diameter and a predetermined length when the first spring is in its neutral position;
the spring system comprises a second spring that is wound counterclockwise, the second spring having a second outer diameter and the predetermined length when the second spring is in its neutral position;
the first outer diameter is one of greater than and less than the second outer diameter;
when the first outer diameter is greater than the second outer diameter, the second spring is located within the first spring; and
when the first outer diameter is less than the second outer diameter, the first spring is located within the second spring.

8. The apparatus of claim 1 wherein:
the spring system comprises: a first spring portion that is wound clockwise and has a first length and a second spring portion that is wound counterclockwise and has a second length; and
the two springs are arranged with centerlines of the two springs being collinear with the length of the spring system in its neutral position is at least as much as the sum of the first and second lengths.

9. The apparatus of claim 1 wherein:
the spring system comprises: a first spring portion that is wound clockwise, has a first length when the first spring portion is in its neutral position, and has two starts;
and a second spring portion that is wound counterclockwise, has a second length when the second spring portion is in its neutral position, and has two starts; and
the two springs are arranged with centerlines of the two springs being collinear and a length of the spring system in its neutral position is at least as much as the sum of the first and second lengths.

10. The apparatus of claim 9 or 10 wherein a connector piece is provided between the first and second spring portions.
